(19) United States
(12) Patent Application Publication
(10) Pub. No.: US 2004/0145910 A1
(43) Pub. Date: Jul. 29, 2004

(54) Lighting assembly

(75) Inventor: Michael F. Lisowski, Anderson, IN (US)

Correspondence Address: RUSSELL E. FOWLER, II, ICE MILLER, ONE AMERICAN SQUARE, BOX 82001, INDIANAPOLIS, IN, 46282-0002, US

(73) Assignee: Guide Corporation (a Delaware Corporation), Pendleton, IN

(21) Appl. No.: 10/353,273

(22) Filed: Jan. 29, 2003

(51) Int. Cl. F21V 7/00

(52) U.S. Cl. 362/519; 362/346; 362/247; 362/545; 362/800

(57) ABSTRACT

A lighting assembly comprising a housing having at least one aperture formed therein and a reflector secured to the housing. The reflector comprises at least one reflector cup having a front curved surface. The lighting assembly further comprises at least one light source, such as an LED, positioned in the at least one aperture and secured to the housing. The at least one light source is positioned to emit light toward the at least one reflector cup and the light may then be focused into a collimated beam. A plurality of light sources may be circumferentially spaced around the outer edge of the reflector.

### BACKGROUND OF THE INVENTION

The present invention relates generally to lighting systems, including vehicle lighting and general and architectural lighting. More specifically, this invention relates to optical systems used in signal lighting, forward lighting, and interior lighting for vehicles.

Motor vehicles are legally required to have external illumination for several reasons. For example, forward lighting systems are necessary to illuminate oncoming road or terrain and to make a vehicle visible to the drivers of other vehicles. Additionally, signal lighting is necessary for vehicles in order to alert others of an intention to slow or stop the vehicle or to change vehicle direction. Indeed, vehicle lighting is a significant safety feature of all types of modern vehicles, including, without limitation, automobiles, boats, planes, and motorcycles.

Currently, there are two common systems for providing vehicle lighting. However, each of these systems has disadvantages that may be overcome with a new vehicle lighting design. The first and most common method used for vehicle lighting is a standard incandescent lamp and reflector. In this type of standard system, a lamp bulb is placed at the focal point of a parabolic reflector. In spite of its widespread use, the standard incandescent lamp system has several disadvantages. First, the efficiency of this type of standard system is primarily determined by the size of the reflector. Thus, small standard incandescent lamp systems have poor efficiency. However, larger standard incandescent lamp systems require additional materials, which causes additional expense. Further, the additional space required by larger standard incandescent lamp systems adds expense to shipping costs and constrains automotive design.

A second common method of meeting vehicle lighting needs is collimating light from light emitting diodes (“LED”). The use of Fresnel optics is a common approach for collimating light from an LED. A typical Fresnel optics system known in the art comprises employing a collimating lens to direct light from an LED array into a specific beam pattern. For example, prior art systems of this type utilize a collimated lens having pillow optics. While this method is simple to manufacture, it often produces a non-uniform light beam. Additionally, Fresnel systems require a constant trade-off between LED spacing and the performance of the Fresnel system. Specifically, the efficiency and the performance of the Fresnel system decreases as the LEDs within the Fresnel system are spaced farther apart. However, spacing the LEDs close together requires the use of more LEDs in order to meet the photometric requirements of the assembly. As more LEDs are used, the expense of the lighting assembly increases.

Additionally, it is worth noting that some of the same disadvantages described above which exist in current prior art vehicle lighting systems also exist in general lighting applications. At the same time, the benefits that the use of LEDs offer in vehicle lighting assemblies also exist for LEDs used in general lighting applications. For example, LEDs have a longer life than standard incandescent light bulbs which are commonly used in general lighting applications. Furthermore, LEDs are smaller than standard light bulbs, and LEDs have a lower overall power consumption. Such benefits make LEDs an attractive option for general lighting applications of all types, including, for example, architectural and building lighting, industrial lighting, outdoor lighting, traffic signal lighting, portable lighting and other types of lighting assemblies. Unfortunately, however, similar to vehicle lighting, many general lighting applications also require emitted light that is focused into a set pattern or beam. As described above, when LEDs are used in conjunction with standard Fresnel optics which are known in the art, the result is often a non-uniform light beam. This is neither aesthetically pleasing nor desired in many types of general lighting applications.

Thus, a need exists for a compact, efficient, functional and inexpensive lighting assembly which comprises LEDs. Additionally, it is desirable to have a lighting assembly that comprises a means of collimating light from LEDs which overcomes the disadvantages of the methods currently employed in the prior art. Finally, it is also desirable that such a lighting assembly not be overly complex or expensive to manufacture.

### BRIEF SUMMARY OF THE INVENTION

A lighting assembly comprises a housing and a reflector secured to the housing. The housing includes a frustro-conical portion having a plurality of apertures. The reflector comprises a plurality of facets, each facet having a front curved reflective surface forming a reflector cup. The lighting assembly further comprises a plurality of light sources secured to the frustro-conical portion of the housing, each of the at light sources inserted through one of the apertures of the housing. In an exemplary embodiment, the at least one light source is positioned to emit light toward the at least one reflector cup. Depending upon the needs of the specific application, light emitted from the lighting assembly may be focused into a collimated beam.

While any number of types of light sources are possible for use in conjunction with the light assembly, one exemplary embodiment comprises an array of LEDs. In the exemplary embodiment, the LEDs are circumferentially spaced around the outer edge of the reflector and positioned in the apertures of the housing.

Additionally, in the exemplary embodiment, the at least one reflector cup is tilted at an angle. Moreover, the exemplary embodiment of the light assembly further comprises a means for electrically connecting the at least one light source to a power supply.

### BRIEF DESCRIPTION OF THE DRAWINGS

FIG. 1 is a front view of one exemplary embodiment of a lighting assembly;

FIG. 2 is a side view of the exemplary embodiment of the lighting assembly of FIG. 1;

FIG. 3 is a perspective view of the exemplary embodiment of the lighting assembly of FIG. 1; and

FIG. 4 is a partial cross-sectional view of the lighting assembly of FIG. 1 along line A-A.

FIG. 5 is the same view as FIG. 4 showing the degree of tilt of LEDs in the lighting assembly with respect to a reference axis.

### DETAILED DESCRIPTION OF THE INVENTION

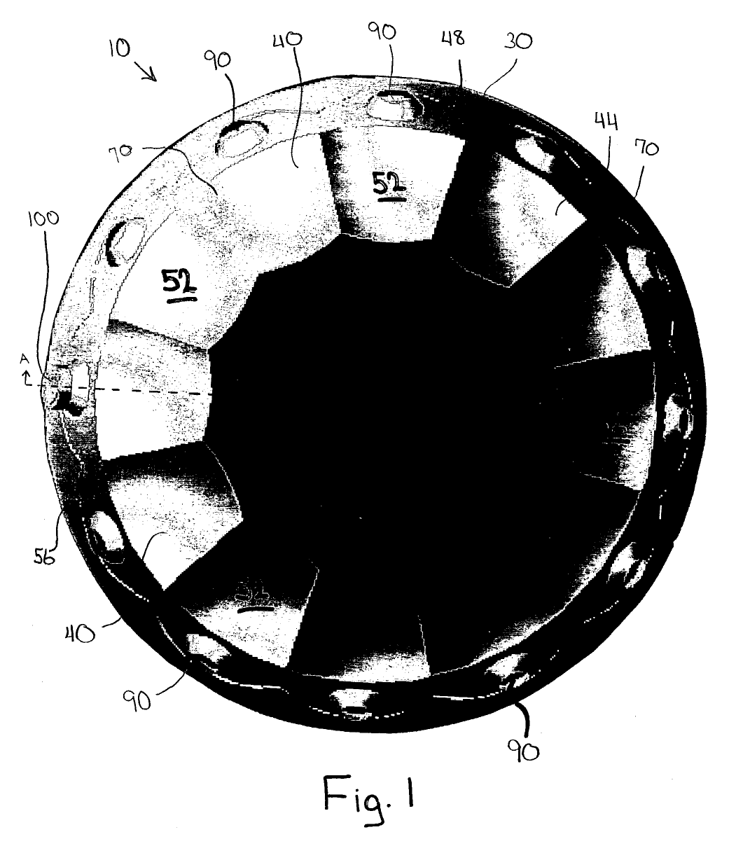

FIGS. 1 through 4 show various views of one exemplary embodiment of a lighting assembly 10. In FIG. 1 there is shown a front view of an exemplary embodiment of lighting assembly 10. Lighting assembly 10 comprises one or more apertures 90 positioned upon a housing 30, each aperture having a LED housing 100 with a LED positioned therein. While the exemplary embodiment described herein contains twelve such apertures and LEDs, it will be appreciated by those of skill in the art that other embodiments of lighting assembly 10 could comprise only a single aperture and LED or any number of a plurality of apertures and LEDs. Additionally, in other exemplary embodiments of the lighting assembly, light sources other than LEDs could be utilized.

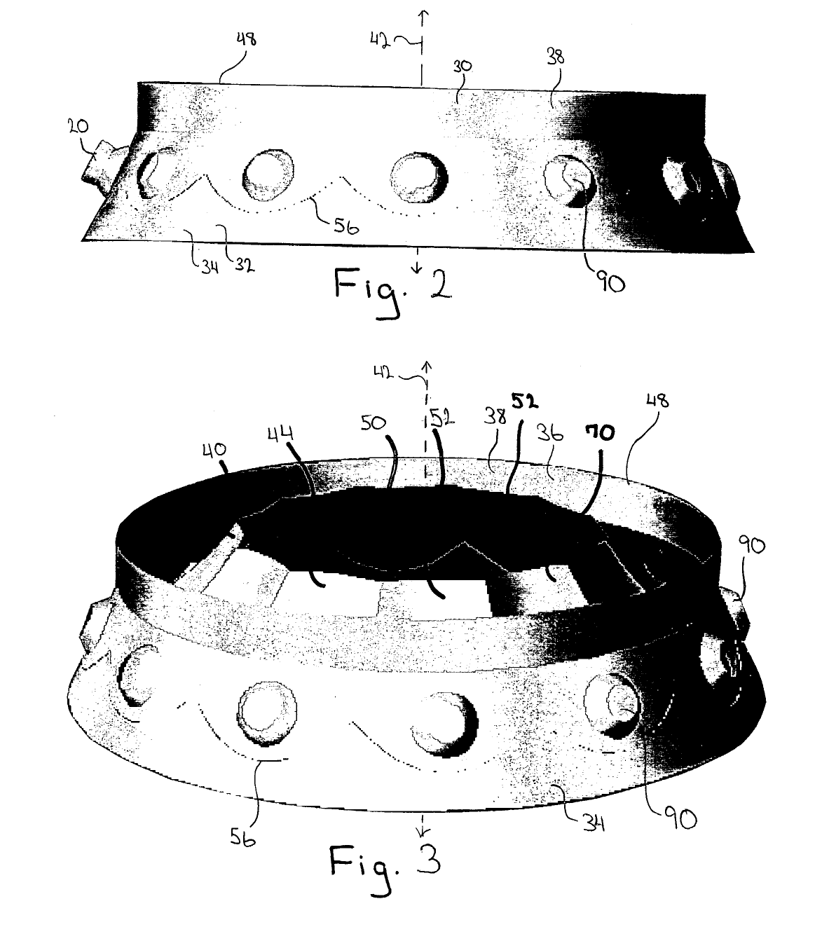

Lighting assembly 10 further comprises a reflector 40 attached to the housing 30. As shown in FIG. 1, housing 30 and reflector 40 are generally circular in shape, as viewed from the front. In other embodiments, housing 30 and reflector 40 could be one of a variety of shapes, for example elliptical or of some irregular shape depending upon the space requirements of the particular application for lighting assembly 10. The housing 30 includes an exterior housing surface 34 and an interior housing surface 36 (see FIG. 3). As shown in FIGS. 2-3, housing 30 also includes a generally frustro-conical wall 32 and a cylindrical crown 38. The frustro-conical wall 32 and cylindrical crown 38 are coaxial about a central axis 42. The cylindrical crown 38 includes a top rim that forms a mouth 48 on the lighting assembly.

Reflector 40 comprises a front side 44 and a rear side (not shown). Reflector 40 further comprises one or more sloped and wedge-shaped facets 52 (also referred to herein as “reflector cups”) arranged about a central cavity 54. Each facet includes a front curved surface 70 that forms a generally parabolical reflective surface. The facets 52 are integral with respect to each other and form a continuous one-piece reflective surface. Each facet 52 is reflective of light on its front curved surface 70. Reflector 40 includes an outer circumference that is attached to the interior surface of the housing 30. The outer circumference of the reflector is represented by the outline 56 shown along the frustro-conical wall 32 of the exterior surface of the housing.

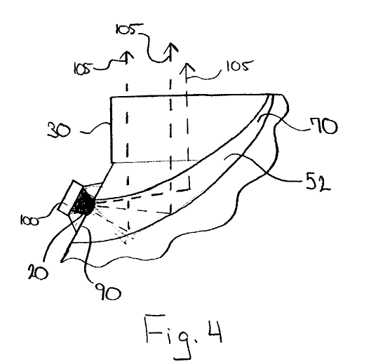

While it is not a requirement, the number of facets 52 will generally correspond on a one-to-one basis with the number of apertures 90 and associated LEDs 20 utilized in a particular embodiment of lighting assembly 10. Again, however, other embodiments are possible. For example, instead of one LED 20 per one facet 90, an exemplary embodiment could comprise two or more LEDs 20 per facet 90. As best seen in FIG. 4, each facet 52 of the reflector is attached to the housing such that the facet extends from below the LED 20 associated with the facet to above the LED associated with the facet. To this end, each aperture 90 on the frustro-conical wall faces the reflective front curved surface 70 of the associated facet so that the LED 20 in the aperture will also face the facet. Likewise, the reflective surface of reflector 40 generally faces the interior surface of the housing. This provides for an arrangement where light emitted from one of the LEDs 20 positioned in the apertures is reflected off the reflector 40 and exits the lighting assembly 10 through the mouth 48 of the cylindrical crown 38. Most of the light exiting the mouth 48 will be substantially parallel to the central axis 42, thereby producing a collimated light beam. Of course, much of the light exiting the mouth 48 will not be exactly parallel to the central axis, as the reflector will direct the light in a desired pattern. For example, light emitted from automotive headlamps must meet certain distribution requirements, and if the lighting assembly is used for such an application, the reflector would be designed to distribute light according to such requirements.

In an alternative embodiment of the lighting assembly, the facets 52 of the reflector 40 are not integral, but are comprised of individual wedge-shaped reflector cups 52 that are joined together to form the reflector. Each wedge-shaped reflector cup 52 is a separate piece which may be manufactured from any one of a variety materials known in the art. In one embodiment, reflector cups 52 are manufactured from polycarbonate by injection molding. Whether the facets 52 of the reflector 40 are formed as a single part with a number of integral facets or as separate facets that are secured to each other, reflector facets 52 are positioned to optimize operation of lighting assembly 10.

The front side of reflector 40 is coated with a reflective material, such as aluminum by a vacuum metalize process. As further described below, this reflective material allows lighted emitted from LEDs 20 to be reflected from the front side 44 of the reflector 40 (i.e., reflected off of each facet 52) and emitted out the front of lighting assembly 10. It will be appreciated by those of skill in the art that other reflective materials, such as for example chrome or reflective paint could be applied to the reflector 40.

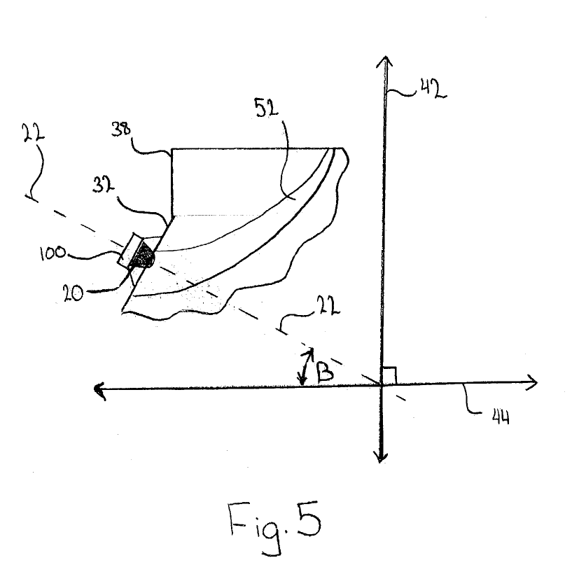

Each LED 20 is positioned upon a LED housing 100. The LED housings 100 are mounted to the exterior surface 34 of the housing with the LEDs extending through the apertures 90 such that light emitted from the LEDs will strike the facets 52 of the reflector. FIG. 4 shows a cross-sectional view of the housing 30 along line A-A of FIG. 1. As shown in FIG. 4, an LED 20 and LED housing 100 is positioned in one of the apertures 90. Dotted lines 105 in FIG. 5 are representative of light emitted from the LED 20 and reflecting from the surface of facet 52. In an exemplary embodiment, LEDs 20 are generally circumferentially and evenly spaced around the outer edge of reflector 40. It will be appreciated by those of ordinary skill in the art that other light source spacings are also possible. LEDs 20 are also positioned within apertures 90 so that LEDs 20 will emit light toward said facets 52. In particular, LEDs are positioned in such a fashion that the angle of the light emitting portion of LEDs 20 is substantially similar to the positioning angle of reflector cups 52 as described previously.

LED housings 100 are mounted to housing 30 in any one of a variety of manners know to those of skill in the art. In the exemplary embodiment, LED housings 100 and associated LEDs 20 are mounted to the housing 30 by speed nuts. In other exemplary embodiments of lighting assembly 10, LED housings 100 and LEDs 20 could be mounted through the use of adhesives, rivets or heat staking. It will also be appreciated by those of skill in the art that in other exemplary embodiments of lighting assembly 10, more than one LED 20 could be mounted within each LED housing 100.

It will be recognized by those of skill in the art that a plug (not shown) may be provided at the rear of each LED 20 and LED housing 100. In one embodiment, each plug is in electrical communication with an electrical conductor (not shown). Each electrical conductor is retained by an electrical harness. Each electrical conductor is in electrical communication with central electrical connector (not shown), found at the rear of lighting assembly 10. The central electrical connector thus provides a centralized means for electrically connecting each LED 20 to a power supply (not shown). Such power supply could be, for example, a vehicle power supply, or a power supply for a general lighting application. It will be appreciated by those of skill in the art that the particular plug, electrical harness, and central electrical connector may be substituted for other means for providing power to the light source. The salient characteristic of the means for electrical connection to a power supply is simply that it provide electrical connectivity between a power source and LEDs 20. Accordingly, means for electrical connection to a power source may include plugs, harnesses or connectors which are integral to reflector 40 or housing 30.

LEDs 20 are arranged and disposed upon the housing 30 to provided a desired effect from the lighting assembly 10. As shown in FIG. 5, LEDs 20 are aligned upon a light source axis (also referred to herein as an LED axis), represented by dotted line 22. In the embodiment of the lighting assembly shown in FIG. 5, the LED axis 22 is substantially perpendicular to the frustro-conical wall 32, and is directed through the aperture 90. This LED axis 22 shows the degree of tilt to the LEDs 20 disposed upon the housing 30. In particular, as shown in FIG. 5, LED axis 22 forms an angle β with respect to reference axis 44. Reference axis 44 is perpendicular with respect to central axis 42. Accordingly, LEDs 20 are tilted at angle β to provide desirable light collimation from the lighting assembly. Generally, angle β will be less than 50 degrees. It has been determined that tilting LEDs 20 between 5 degrees and 30 degrees is particularly desirable for operation of the lighting assembly 10. Even more specifically, it has been determined that tilting LEDs 20 at an angle of approximately 25 degrees provides a particularly desirable beam of collimated light. While tilting LEDs 20 at an angle greater than 50 degrees will not render lighting assembly useless, it has been determined that an LED tilt of more than 50 degrees results in an undesirable amount of light being reflected back against frustro-conical wall 52, thereby significantly decreasing the efficiency of the lighting assembly.

In operation, LEDs 20 of lighting assembly 10 emit light into reflector cups 52 of reflector 40. Due to the positioning of not only LEDs 20, but also reflector cups 52, the light emitted by LEDs 20 is gathered by reflector 40 and focused into an appropriate photometric beam pattern. The specific shape of front curved surface 70 of reflector cups 52 provides for the focusing of the desired light beam pattern into a collimated beam. In the exemplary embodiment, front curved surface 70 is slightly parabolic in shape. It will be appreciated by those of skill in the art that in other exemplary embodiments front curved surface 70 may be of a different shape depending upon the photometric requirements of the particular application for lighting assembly 10.

When the lighting assembly is used in automotive applications, the lighting assembly 10 is positioned in the automobile such that the body of the automobile surrounds the cylindrical crown 38, and the exterior surface 34 of the housing 30 is hidden from view by the body of the automobile. With such an arrangement, the reflector is open to inspection, with the facets 52 of the reflector and the central cavity 54 exposed. A decorative plate (not shown) may be inserted into central cavity for aesthetic purposes. LEDs inserted through apertures are only visible upon close inspection when looking at the lighting assembly from a side position, as the LEDs are recessed behind the frustro-conical wall of the housing. The LEDs are not visible from the front view of the lighting assembly. Accordingly, the lighting assembly provides a automotive lighting apparatus that does not require a bulb shield for use in association with its light source(s). This arrangement provides an aesthetically pleasing lighting assembly capable of providing collimated light.

Those of skill in the art will realize that as described herein, the lighting assembly provides significant advantages over the prior art. For example, lighting assembly 10 minimizes the required spacing and number of LEDs 20 without negatively affecting the performance or efficiency of a lighting assembly. Additionally, the positioning of LEDs 20 around a central axis significantly reduces the overall depth of lighting assembly 10 in comparison to other prior art assemblies that require the use of Fresnel or other optics. Such a space savings is an important advantage in both vehicular and general lighting applications. Additionally, the lighting assembly overcomes a significant disadvantage of prior art LED lighting assemblies by providing for uniform emitted light. Furthermore, because the lighting assembly does not require the use of Fresnel optics, the center of reflector 40 remains uncluttered and could be used for the placement of company logos, trade names, or other content. Other features of the lighting assembly will be apparent to those of skill in the art in consideration of the above description, the accompanying drawings and the following claims.

Although the lighting assembly has been described in considerable detail with reference to a certain exemplary embodiment thereof, such is offered by way of a non-limiting example of the lighting assembly, as other versions are possible. It is anticipated that a variety of other modifications and changes will be apparent to those having ordinary skill in the art. Therefore, the spirit and scope of the appended claims should not be limited to the description of the exemplary embodiment contained herein, and the claims should be given the broadest possible interpretation to protect the novel features of the lighting assembly.

1. A lighting assembly comprising:
a housing having a plurality of apertures;
a reflector having an outer circumference secured to said housing, said reflector comprising a plurality of reflector cups, each of said reflector cups having a front curved surface; and
a plurality of light sources positioned in said plurality of apertures and secured to said housing, said plurality of light sources positioned to emit light toward said plurality of reflector cups.

2. The lighting assembly of claim 1 wherein said light emitted from said at least one light source is reflected from said plurality of reflector cups and focused into a collimated beam.

3. The lighting assembly of claim 1 wherein said front curved surface of said at least one reflector cup has a parabolic shape.

4. The lighting assembly of claim 1 wherein the housing comprises a frustro-conical wall.

5. The lighting assembly of claim 4 wherein said housing further comprises a cylindrical crown attached to the frustro-conical wall.

6. The lighting assembly of claim 1 wherein a central cavity is located at the center of the reflector.

7. The lighting assembly of claim 1 further comprising a plurality of light source housings secured to said plurality of light sources.

8. The lighting assembly of claim 1 wherein said plurality of light sources comprise a plurality of LEDs.

9. The lighting assembly of claim 1 further comprising a center axis that is substantially parallel to a desired direction of light distribution from the lighting assembly.

10. The lighting assembly of claim 9 wherein said at least one light source is tilted upon a light source axis at an angle relative to a reference axis that is perpendicular to the center axis.

11. The lighting assembly of claim 10 wherein said angle is less than 50 degrees.

12. The lighting assembly of claim 10 wherein said angle is between 5 and 30 degrees.

13. The lighting assembly of claim 10 wherein said angle is 25 degrees.

14. The lighting assembly of claim 1 wherein said plurality of reflector cups are integrally formed as one part.

15. The lighting assembly of claim 1 wherein said reflector is substantially circular in shape.

16. A lighting assembly comprising
a. an assembly housing having a frustro-conical wall;
b. a plurality of light sources positioned around the frustro-conical wall;
c. a reflector having a plurality of facets attached to the frustro-conical wall, each of the plurality of facets including a front curved surface that extends from below one of the plurality of light sources to above one of the plurality of light sources.

17. The lighting assembly of claim 16 wherein the assembly housing further comprises a crown adjacent to the frustro-conical wall.

18. The lighting assembly of claim 16 wherein the assembly housing further comprises an exterior surface, an interior surface and a plurality of apertures extending between the interior surface and the exterior surface.

19. The lighting assembly of claim 18 wherein each of the plurality of light sources is joined to a light source housing attached to the assembly housing at one of the plurality of apertures such that each of the plurality of light sources extends through the aperture.

20. An automotive lighting assembly for creating a collimated beam of light, the automotive lighting assembly comprising:
a. an assembly housing having a frustro-conical wall and a cylindrical crown extending from the frustro-conical wall, the assembly housing forming an interior surface and an exterior surface and the cylindrical crown forming a mouth on the automotive lighting assembly;
b. a reflector joined to the frustro-conical wall, the reflector including a reflective surface facing the interior surface of the assembly housing;
c. a plurality of apertures positioned around the frustro-conical wall, each of the plurality of apertures facing the reflector;
d. a plurality of LEDs positioned in the plurality of apertures such that light emitted from the LEDs will strike the reflective surface of the reflector and exit the automotive lighting assembly through the mouth.
